(19) United States
(12) Patent Application Publication
(10) Pub. No.: US 2009/0309028 A1
(43) Pub. Date: Dec. 17, 2009

(54) Intelligent system and method to monitor object movement

(75) Inventors: Vijendran G. Venkoparao, Bangalore (IN); Gudi Ravindra, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/482,374

(22) Filed: Jun. 10, 2009

(30) Foreign Application Priority Data
Jun. 16, 2008 (IN) 1432/DEL/2008

(51) Int. Cl. G01N 21/00; G01J 5/00; G01J 5/02

(52) U.S. Cl. 250/338.5; 374/121; 250/340; 374/E13.001

(57) ABSTRACT

Real time performance of a combustion process is evaluated by comparing sensor data with a template. Sensor data is derived from a passive infrared system and corresponds to specific heat capacity. Analysis of the real time performance can be used to control a parameter of the combustion process.

### CROSS REFERENCE TO RELATED APPLICATIONS

This application claims priority to India Patent Application No. 1432/DEL/2008, filed Jun. 16, 2008, which is incorporated herein by reference.

### BACKGROUND

A flue vents emissions to the atmosphere. One type of flue, known as a gas flare, or flare stack, includes an elevated vertical stack or chimney for burning off unwanted gas or flammable gas and liquids released by a pressure relief valve during over-pressuring of plant equipment. A flue is often found on an oil well, an oil rig, in a refinery, a chemical plant, a landfill, or other such facility.

Some emissions from a flare stack are harmful as well as colorless. Examples of colorless emissions include hydrogen and hydrogen sulphide.

Regulatory guidelines, such as those of the Kyoto Protocol or the United States of America Environmental Protection Agency (EPA), impose requirements for monitoring and controlling emissions in terms of the quantity and composition. Monitoring currently relies on technology that is not suitable for use with colorless emissions.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of a system according to an example embodiment.

FIG. 2 illustrates a method according to an example embodiment.

FIG. 3 illustrates a method according to an example embodiment.

FIG. 4 illustrates a pictorial representation of analysis according to an example embodiment.

FIG. 5 illustrates a flow chart for a method according to an example embodiment.

FIG. 6 illustrates a configuration for three-dimensional data collection and analysis according to an example embodiment.

### DETAILED DESCRIPTION

The technical problem addressed herein can be described as monitoring colorless flue emissions. The technical solution to this problem includes using a passive infrared sensor and a processor configured to sample emissions and analyze specific heat capacity using a template.

Unlike some monitoring technologies that treat emissions in the aggregate and are unable to discern colorless emissions, a system according to an example embodiment enables monitoring of individual components of colorless emissions. The improved granularity allows for more efficient control of the emission generating facility and effective notification of excursions from normal performance.

An example embodiment includes an infrared (IR) sensor for monitoring colorless emissions from a refinery. The data from the sensor corresponds to a temperature difference between the background and the actual emission in the captured IR image. A difference in specific heat capacity between different components in the emission appears as different shades of gray in the captured IR image. The distribution of the gray levels are analyzed statistically and one or more templates of distributions (corresponding to normal behavior, for example) are generated.

The one or more templates are used for comparison during monitoring to analyze abnormalities in the emissions and for generating a remedial corrective measure via process control. The abnormal behavior can be caused by an increase in a certain component in the emission and when the increase is detected, the present system generates a corrective feedback control signal. The control signal affects the process, for example, to improve combustion of these components before they are sent to the flare stack.

One example includes a system having at least one infrared sensor and a processor. The sensor is configured to provide sensor data based on a gaseous emission from a flue. The processor is in communication with the sensor and is configured to execute a set of instructions to generate an output signal using analysis of specific heat capacity of the gaseous emission.

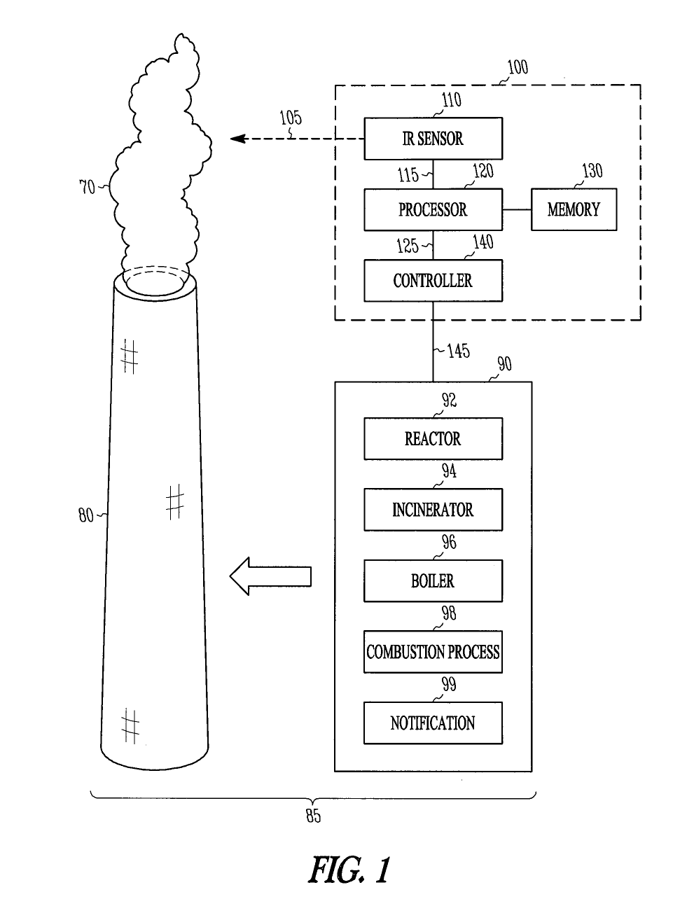

FIG. 1 illustrates one example of system 100 configured for monitoring emissions 70. Emissions 70 are vented to the atmosphere from facility 85. Facility 85 includes stack 80 and emissions generator 90. Emissions from stack 80 are directly related to the performance of emissions generator 90. Facility 85 can include an oil well, an oil rig, a refinery, a chemical plant, a biofuel plant, a landfill, or other such facility. In one example, stack 80 is referred to as a sulphur stack.

Typical gaseous emissions from processing feed stocks include hydrogen sulfide (H₂S), sulphur dioxide (SO₂), and carbon dioxide (CO₂), some of which are commonly referred to as acid gases. One example system is directed to monitoring and controlling emissions of acid gas in an industrial process and to reduce sulphur that would otherwise vent to the atmosphere. In addition to adjusting emissions, one example system is directed to issuing a notification or triggering an alarm based on analysis of gaseous specific heat capacity from a passive sensor.

Sensor 110, in one example, includes a passive infrared sensor to monitor a plume of emissions from stack 80. Processor 120, in communication with sensor 110 generates an output based on a comparison of real time emission with data embodied in a template. The template, along with the real time data from sensor 110, includes a gray scale representation of the constituent elements of the plume. Analysis of the real time emissions data, using the template, provides a measure of emissions and can reveal an excursion from normal operation. A control signal generated by the processor is then provided to the emissions generator which can adjust an operating parameter to manage the output from stack 80.

In FIG. 1, emissions generator 90 includes various equipment, some of which are represented here as reactor 92, incinerator 94, boiler 96, combustion process 98, and notification 99. Reactor 92 can include a Claus reactor configured to implement a gas desulphurizing process. Incinerator 94 can include a tail gas incinerator. Boiler 96 can include a waste heat boiler. Combustion process 98 can include other equipment such as a valve, a damper, a pump, a regulator, a hopper controller, or other type of equipment. Notification 99 can include an alarm, a history record, or other notification to denote occurrence of a particular condition. The examples depicted here are merely representative and others can also be included.

Operational parameters that affect the quantity and the composition of the plume constituents from emissions generator 90 can be managed by a signal on communication link 145.

System 100 includes sensor 110, processor 120, memory 130, and controller 140. Sensor 110 is coupled to processor 120 by communication link 115 and processor 120 is coupled to controller 140 by communication link 125. In addition, controller 140 is coupled to emissions generator 90 by communication link 145. Any of communication links 115, 125, and 145 can include a wired or a wireless connection. A wired connection can include an RS-232 connector, Ethernet connection, or other wired connection. Examples of wireless connections include Bluetooth or other communication protocol such as that which is compatible with a networking protocol specified in IEEE 802. The communication range of communication links 115, 125, and 145 can be configured to allow remote monitoring of a plume from stack 80. System 100, as denoted by the dashed line, represents but one example of a configuration, and the various components can be distributed or combined. In one example, the various elements are connected by a communication network.

Sensor 110 includes a passive infrared detector. A passive sensor operates on the basis of background energy and does not require a synchronized source of light or energy. Sensor 110 can include a video camera or a still camera.

Sensor 110 can be configured for sensitivity to thermal spectral content and, in one example, is sensitive to emissions having a temperature in the range of 300 to 400° C. although other temperatures (especially if a flame is present) are also contemplated. In one example, sensor 110 is sensitive to energy having a wavelength in the range of 8 to 12 μm, however, other ranges are also contemplated.

Sensor 110 is positioned and aimed to monitor the emissions from stack 80, as shown at dashed line 105. Sensor 110 can be located near stack 80 or it can be located remotely. In one example, the distance between sensor 110 and stack 80 is typically 500 m to 1 km.

Processor 120 and memory 130 are in communication with sensor 110 by communication link 115. Content stored in memory 130 can include a set of instructions for execution by processor 120. In one example, memory 130 provides storage for a template or other information. For example, memory 130 can include a look up table, operational parameters, historical data and other information.

Processor 120 can include a server, a workstation, a digital signal processor (DSP), an analog signal processor, a personal computer, or other processor tailored to implement the methods described herein.

Memory 130 can include a read only memory (ROM), a random access memory (RAM), a FLASH memory, or other type of storage device.

Processor 120 executes an algorithm to analyze the data provided by sensor 110 in order to determine presence and volume of a constituent gas element. In one example, processor 120 generates an output signal for managing the operation of facility 85. For example, processor 120 can provide a signal, on communication link 125, to cause controller 140 to adjust a temperature in reactor 92. In one example, controller 140 includes a digital-to-analog converter, a buffer, a driver, or other circuit to generate an output signal. In one example, processor 120 generates an output signal to signal an alarm or other notification, as denoted at notification 99. Notification 99, in various examples, can include an audible or visible alarm, a marker or other signal correlated to a detected event and stored in a memory.

In one example, processor 120 executes an algorithm to generate a bit-map of data corresponding to emissions from stack 80. A gray scale based on the bit-map corresponds to type and amount of constituent elements. Processor 120 analyzes a temperature difference between the background image and the actual emission from stack 80 embodied in the image captured by sensor 110. The differences in specific heat capacity between different gaseous components in the emission are represented as different shades of gray in the image captured by sensor 110. The distributions of these gray levels is analyzed statistically to determine composition and quantity of the constituent elements in the emission plume. Memory 130 stores one or more templates of gray scale distributions, corresponding to normal (or abnormal) performance. The templates enable monitoring of stack 80 to analyze abnormalities in emissions and to manage remedial corrective measures via process control.

This data consists of temperature difference of the various regions in the image represented in terms of two dimensional bit-maps. These bit-maps are statistically analyzed for specific distribution corresponding to components of various gases. A template corresponding to normal operations is established from these statistical distributions. Real time emissions are analyzed by projecting an image (taken during actual operation) onto the template. A deviation from the template indicates abnormal behavior.

Processor 120 and memory 130 are illustrated as discrete components, however, either or both can be distributed or embodied on a single device. In one example, processor 120 and memory 130 are in communication via a digital network.

Controller 140 is configured to receive data from processor 120. Controller 140, in various examples, includes a digital-to-analog converter, a buffer, a driver, or other circuit to generate a control signal or a notification signal on communication link 145.

In various examples, a parameter for a process implemented by emissions generator 90 is adjusted or managed in response to a control signal received using communication link 145. For example, controller 140 may call for a change in a fuel feed rate for emissions generator 90. The plume emitted from stack 80 changes in response to a change in the fuel feed rate.

A variety of process controls can be managed by controller 140. For example, the fuel supplied to a burner or boiler can be adjusted, the operation of a scrubber unit can be controlled, or a setting of a pressure relief valve can be adjusted. In addition, a particular process variable, such as a fuel flow rate, combustion air, a sulphur recovery process, a damper position, an operating temperature, or other process control elements can be modulated by controller 140.

System 100 can be configured as a portable device or as a stationary unit for continuous emission monitoring. For example, as a portable device, processor 120 is powered by a battery. As a stationary unit, system 100 is powered by a metered line service.

FIG. 2 illustrates method 200 according to one example. At 210, a template is received. The template can be accessed from a memory location (such as memory 130), received from a storage device, or otherwise received. The template represents time-wise data collected over an extended period of time and corresponds to normal (or abnormal) operation of facility 85. The template provides a baseline by which the real time data from sensor 110 is compared.

In one example, the template is generated using the same stack that is later monitored, however, in another example, a template corresponding to emissions from one stack is used to monitor emissions of a second, and different, stack.

The template represents historical data and enables detection of a deviation from normal operation.

At 220, real time data from sensor 110 is received. The real time data represents time-wise emissions from stack 80. In one example, the real time data includes gray scale bit-maps of infrared images.

At 230, the sensor data and template are evaluated. This can include executing an algorithm using a processor, such as that represented by processor 120. The algorithm includes statistical analysis of the distribution of the gray scales to determine the quantity and composition of the emission.

At 240, an output is generated. The output can be provided to a notification function or can be used to control a process implemented by facility 85. In one example, this can include managing the operation of a stack scrubber or ventilator.

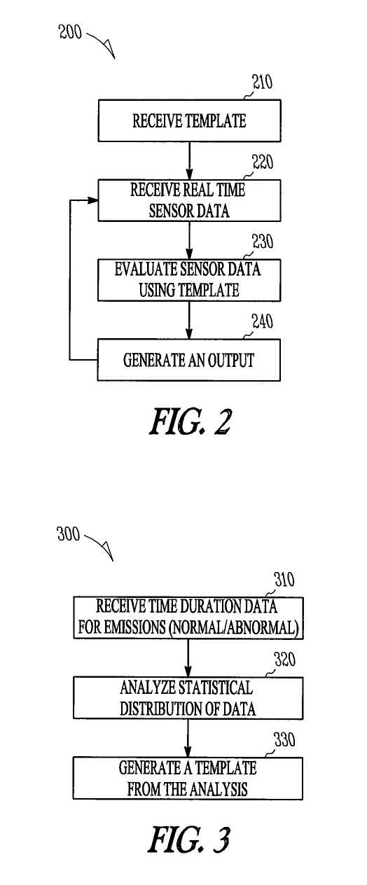

FIG. 3 illustrates method 300, according to one example, for generating a template.

At 310, time duration data for emissions from a stack are received. The data can be received by a processor such as that represented by processor 120. The data can represent normal emissions (or abnormal) emissions. The data includes time-wise representations of emissions from a particular stack 80 that will later be monitored.

At 320, the statistical distribution of the emission data is analyzed and at 330, a template is generated from the analysis. The template can be represented as a gray scale encoded bit-map.

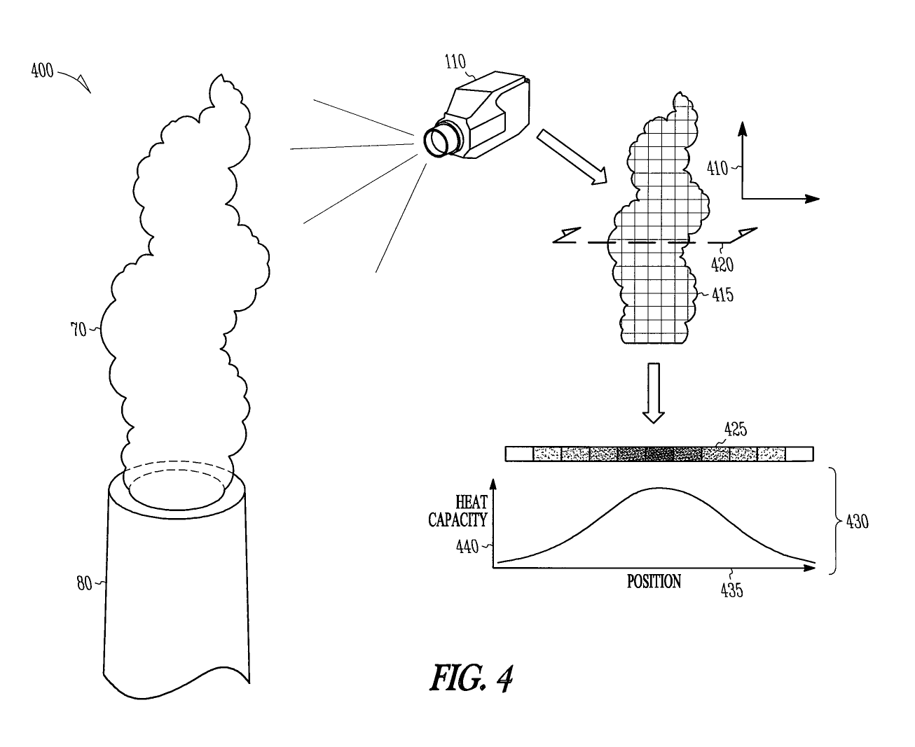

FIG. 4 illustrates pictorial representation 400 for one example. An image of emission 70 from stack 80 is captured by sensor 110. In this example, sensor 110 includes a camera which provides data to processor 120 (not shown in this view). Processor 120 generates bit-map representation 415 of the plume atop stack 80. The bit-map representation is encoded in two dimensions corresponding to the viewing angle of sensor 110 and as shown by orthogonal coordinates 410. Slice 420, through bit-map representation 415, is illustrated as row 425 having variations of a gray scale. At 430, the statistical distribution of the gray scale is embodied in a two-dimensional representation of specific heat capacity (along axis 440) versus position in the plume (along axis 435).

The gray scale reveals variations in molecular content of the plume using data from the infrared sensor. The various regions in the plume exhibit different thermal capacity. For example, the data from the sensor may show that the plume includes 40% H₂S, 30% SO₂, and 30% CO₂. The spectral data from the sensor is mapped to a gray scale to discern the constituent elements of the plume. In one example, a measure of the number of pixels in an image (frequency) having a particular gray scale level is presented as a histogram. In one example, the processor executes an algorithm to perform correspondence analysis in order to determine plume constituent elements. A boundary in a bi-plot can be established using the results of the correspondence analysis and excursions of emissions beyond the boundary can trigger correction or notification. As compared with a histogram, correspondence analysis enables tighter thresholds for which the plant process can be controlled. In one example an excursion of greater than one or two standard deviations will trigger an alarm signal, a control signal, or a notification signal.

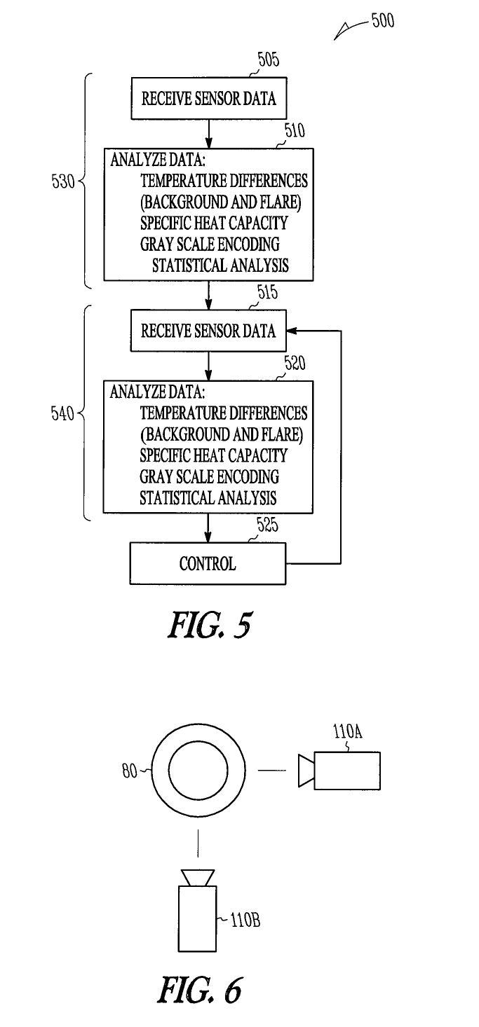

FIG. 5 illustrates a flow chart for method 500 according to one example. Portions of method 500 can be executed by an algorithm using a processor, such as that represented by processor 120. Method 500 includes offline portion 530 (for generating a template) and online portion 540 (for analyzing real time data).

Offline portion 530 includes, at 505, receiving sensor data corresponding to a reference emission. The sensor data is collected over an extended period of time and is indicative of normal or abnormal operation. At 510, the data is analyzed in terms of temperature differences (between the background and the image of the flare from the stack). In particular, the data corresponds to specific heat capacity and is encoded in a gray scale, represented as a bit-map. Analysis also includes statistical analysis to establish long term average composition of the plume.

Online portion 540 includes, at 515, receiving sensor data corresponding to a particular emission. The sensor data is collected while stack 80 is emitting a plume. The sensor data provides real time information as to the process and the content and quantity of emission in the plume. At 520, the sensor data is analyzed in terms of temperature differences (between the background and the image of the flare from the stack). In particular, the data corresponds to specific heat capacity and is encoded in a gray scale, represented as a bit-map.

Analysis also includes statistical analysis to establish the composition and quantity of emissions in the plume. Analysis includes comparing real time data from the sensor with the template generated in the offline portion. In one example, this includes projecting a real time image onto the template.

At 525, the output of the analysis includes a control signal which is configured to manage the process supplying the stack. The control signal can be configured to manage the operation of a stack scrubber, a fuel product supplied to the process, a pressure relief valve setting, or any other operating parameter that affects the emissions from stack 80.

FIG. 6 illustrates a view of stack 80 along with sensors 110A and 110B, each of which are directed to monitor emissions. Sensors 110A and 110B are in orthogonal alignment to provide three-dimensional information to processor 120. Using three-dimensional information, the analysis by processor 120 can yield volumetric information as to the quantity or flow rate of emissions from stack 80. Other configurations for sensor alignment are also contemplated. With a single sensor, an oval-shaped plume will yield data in a two-dimensional representation (bit-map). Using a single sensor, the emissions volume can be estimated using a stack flow rate sensor.

One example of a system can be configured for monitoring and controlling gases from various types of flues. One example system can be used to monitor gaseous emissions from the exhaust of an internal combustion engine such as that found on a motor vehicle. An automotive flue gas analyzer can provide analysis of exhaust emissions from a vehicle tailpipe.

One example embodiment includes a method. The method includes generating a template corresponding to a bit-map representation of specific heat capacity for an emission from a flue. Infrared sensor data corresponding to a real time emission from the flue is received. The method also includes evaluating the real time emission by comparing the sensor data with the template and generating a control signal based on the evaluating. The infrared sensor data can include data as to specific heat capacity. The data, in one example, is represented as a gray scale. Evaluating the real time emissions can be evaluated by analyzing a temperature difference. One example includes executing a correspondence analysis algorithm.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
at least one infrared sensor configured to provide sensor data based on a temperature of a gaseous emission from a flue; and
a processor in communication with the at least one sensor and configured to execute a set of instructions to generate an output signal using analysis of specific heat capacity of the gaseous emission based on the temperature.

2. The system of claim 1 wherein the processor is configured to compare sensor data with a template.

3. The system of claim 1 wherein the processor is configured to execute a correspondence analysis algorithm.

4. The system of claim 1 wherein the at least one infrared sensor includes a plurality of sensors configured to provide sensor data based on a volume of the gaseous emission.

5. A method comprising:
receiving a template corresponding to a reference emission from a flue;
receiving real time infrared sensor data for a particular emission from the flue;
evaluating the sensor data based on a comparison with the template; and
generating an output based on the evaluating.

6. The method of claim 5 wherein receiving the template includes receiving time-dependent data.

7. The method of claim 5 wherein receiving the template includes receiving temperature data.

8. The method of claim 7 wherein receiving temperature data includes evaluating background temperature data.

9. The method of claim 7 wherein receiving temperature data includes receiving specific heat capacity data.

10. The method of claim 5 wherein receiving the template includes receiving normal performance data.

11. The method of claim 5 wherein evaluating the sensor data includes comparing temperature data as to a selected region of a sensor image.

12. The method of claim 5 wherein evaluating the sensor data includes comparing data formatted in a bit-map.

13. The method of claim 5 wherein evaluating the sensor data includes evaluating differences in specific heat capacity.

14. A system comprising:
a sensor configured to provide sensor data for a particular emission from a flue;
a memory device configured to store a template corresponding to a reference emission from the flue; and
a processor configured to compare the sensor data and the template and generate an output, wherein the output corresponds to the particular emission.

15. The system of claim 14 wherein the template includes specific heat capacity for the particular emission.

16. The system of claim 14 wherein the sensor provides data corresponding to infrared radiation.

17. The system of claim 14 wherein the sensor is configured to evaluate a temperature difference.

18. The system of claim 14 further including a controller coupled to the processor, the controller configured to manage a combustion parameter associated with the flue.

19. The system of claim 14 wherein the processor is configured to project an image based on the sensor data onto the template.

20. The system of claim 14 wherein the sensor and the processor are configured for wireless communication.
